(19) United States
(12) Patent Application Publication
(10) Pub. No.: US 2025/0263004 A1
(43) Pub. Date: Aug. 21, 2025

(54) MOTORIZED VEHICLES FOR TRANSPORTING MATERIAL

(71) Applicant: LHD Machinery LLC, Cicero, IN (US)

(72) Inventors: Tony ABRAMS, Cicero, IN (US); Jeff ZURAWSKI, Noblesville, IN (US); Kevin STUTEY, Carmel, IN (US)

(21) Appl. No.: 19/054,674

(22) Filed: Feb. 14, 2025

Related U.S. Application Data
(60) Provisional application No. 63/554,896, filed on Feb. 16, 2024.

(51) Int. Cl. B60P 1/04; B60K 5/00; B62D 5/06

(52) U.S. Cl. CPC B60P 1/04; B62D 5/062; B60K 5/00

(57) ABSTRACT

A motorized vehicle is provided for transporting material and selectively dumping the material from the vehicle. In one example, the motorized vehicle includes a frame, first and second forward wheel assemblies coupled to the frame, and a rearward wheel assembly coupled to the frame. An engine is supported by the frame and configured to rotate the first and second forward wheel assemblies to move the motorized vehicle. And, a steering assembly comprising a power steering unit is configured to move the first and second tires of the rearward wheel assembly, via the power steering unit, for steering the motorized vehicle. The motorized vehicle also includes a bucket supported by the frame and configured to hold material on the motorized vehicle and selectively dump the material from the motorized vehicle, the bucket assembly disposed adjacent the first and second forward wheel assemblies.

### CROSS-REFERENCE TO RELATED APPLICATIONS

This application claims the benefit of, and priority to, U.S. Provisional Application No. 63/554,896, filed Feb. 16, 2024. The entire disclosure of the above application is incorporated herein by reference.

### FIELD

The present disclosure is generally directed to motorized vehicles (e.g., power buggies, etc.) for transporting material and methods related thereto.

### BACKGROUND

This section provides background information related to the present disclosure which is not necessarily prior art.

Power buggies are often used to haul material from one location to another, for example, at construction sites, etc. The buggies can generally handle loads of material ranging from a few hundred pounds up to a few tons. In addition, the buggies are generally sized to operate in smaller areas than conventional dump trucks or concrete trucks, for example, along narrow paths, between doorways, within structures, etc. In connection therewith, the buggies typically include buckets for holding the material being hauled, and for subsequently dumping the material directly in front of the buggies. Operators walk behind the buggies, or stand on platforms or sit on seats mounted on rearward portions of the buggies to control the hauling movements and dumping actions.

### SUMMARY

This section provides a general summary of the disclosure, and is not a comprehensive disclosure of its full scope or all of its features.

Example embodiments of the present disclosure are generally directed to motorized vehicles for transporting material. In one example embodiment, such a motorized vehicle generally includes a frame having a longitudinal axis; first and second forward wheel assemblies, the first forward wheel assembly including at least one tire disposed toward a first side of the frame and the second forward wheel assembly including at least one tire disposed toward a second side of the frame, the at least one tire of the first forward wheel assembly spaced apart from the at least one tire of the second forward wheel assembly along a forward axis, the forward axis disposed generally perpendicular to the longitudinal axis of the frame; a rearward wheel assembly including a first tire disposed toward the first side portion of the frame and a second tire disposed toward the second side portion of the frame, the first tire of the rearward wheel assembly spaced apart from the second tire of the rearward wheel assembly along a rearward axis, the rearward axis disposed generally perpendicular to the longitudinal axis of the frame; an engine supported by the frame and configured to rotate the at least one tire of the first forward wheel assembly and the at least one tire of the second forward wheel assembly to thereby move the motorized vehicle; a steering assembly comprising a power steering unit, the steering assembly configured to move the first and second tires of the rearward wheel assembly, via the power steering unit, for steering the motorized vehicle; and a bucket assembly supported by the frame and configured to hold material on the motorized vehicle and selectively dump the material from the motorized vehicle, the bucket assembly disposed adjacent the first and second forward wheel assemblies.

In another example embodiment, such a motorized vehicle generally includes a frame having a longitudinal axis; first and second forward wheel assemblies coupled to the frame, the first forward wheel assembly disposed toward a first side of the frame and the second forward wheel assembly disposed toward a second side of the frame; a rearward wheel assembly coupled to the frame; an engine supported by the frame and configured to rotate the first and second forward wheel assemblies to thereby move the motorized vehicle; a steering assembly comprising a power steering unit, the steering assembly configured to move the rearward wheel assembly, via the power steering unit, to steer the motorized vehicle; and a bucket supported by the frame adjacent the first and second forward wheel assemblies, the bucket configured to hold material on the motorized vehicle and selectively dump the material from the motorized vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view of a motorized vehicle including one or more aspects of the present disclosure, with a bucket of the motorized vehicle shown in a hauling position;

FIG. 2 is another isometric view of the motorized vehicle of FIG. 1;

FIG. 3 is a rear elevation view of the motorized vehicle of FIG. 1;

FIG. 4 is a bottom isometric view of the motorized vehicle of FIG. 1;

FIG. 5 is another bottom isometric view of the motorized vehicle of FIG. 1;

FIGS. 6-10 are fragmentary isometric views of a steering assembly of the motorized vehicle of FIG. 1;

FIG. 11 is a side elevation view of the motorized vehicle of FIG. 1;

FIG. 12 is a top plan view of the motorized vehicle of FIG. 1;

FIG. 13 is an isometric view of the motorized vehicle of FIG. 1, with the bucket shown in a forward dumping position;

FIG. 14 is an isometric view of the motorized vehicle of FIG. 1, with the bucket shown in a left-side hauling position;

FIG. 15 is the isometric view of the motorized vehicle of FIG. 14, with the bucket shown in a left-side dumping position;

FIG. 16 is a front elevation view of the motorized vehicle of FIG. 15;

FIG. 17 is a top plan view of the motorized vehicle of FIG. 15;

FIG. 18 is an isometric view of the motorized vehicle of FIG. 1, with the bucket shown in a right-side hauling position;

FIG. 19 is the isometric view of the motorized vehicle of FIG. 18, with the bucket shown in a right-side dumping position;

FIG. 20 is a front elevation view of the motorized vehicle of FIG. 19;

FIG. 21 is a top plan view of the motorized vehicle of FIG. 19;

FIG. 22 is a fragmentary isometric view of the motorized vehicle of FIG. 1, with a bucket assembly of the vehicle removed;

FIG. 23 is a bottom plan view of the bucket assembly of the motorized vehicle of FIG. 1;

FIG. 24 is a schematic view of the motorized vehicle of FIG. 1, illustrating an engine of the motorized vehicle coupled to various components thereof; and

FIG. 25 is a schematic view of the motorized vehicle of FIG. 1, illustrating an example steering assembly suitable for use in the motorized vehicle.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

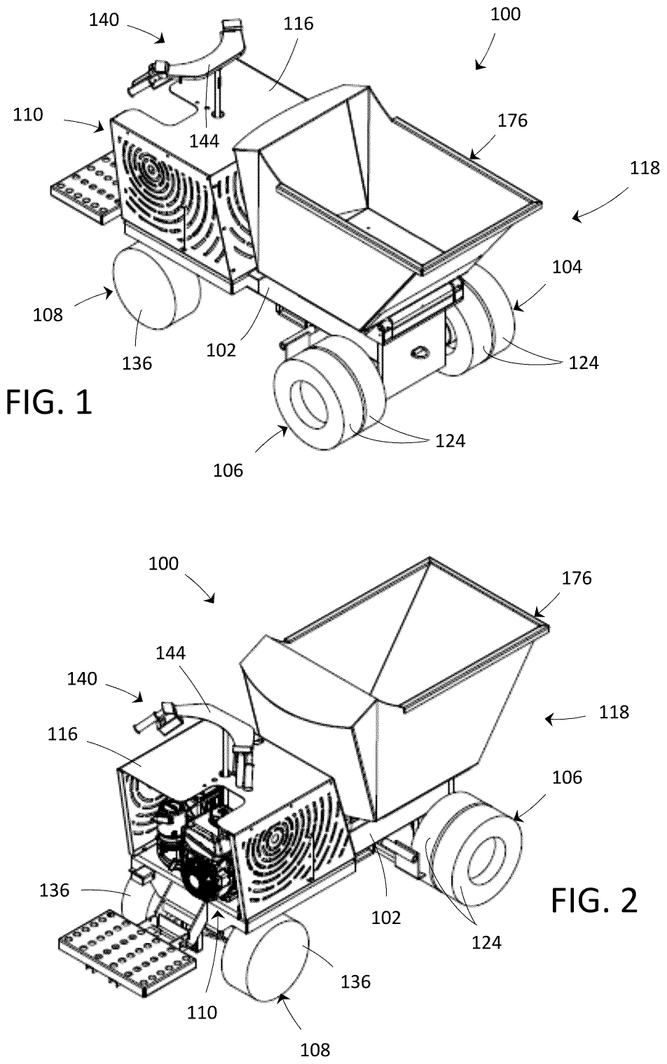

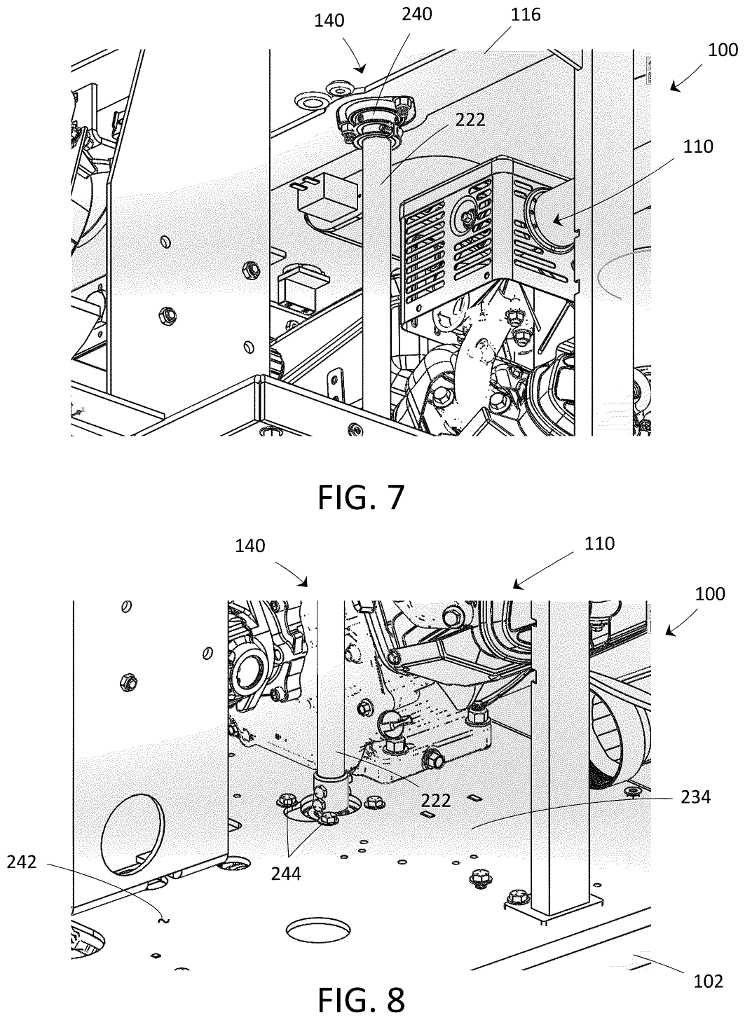

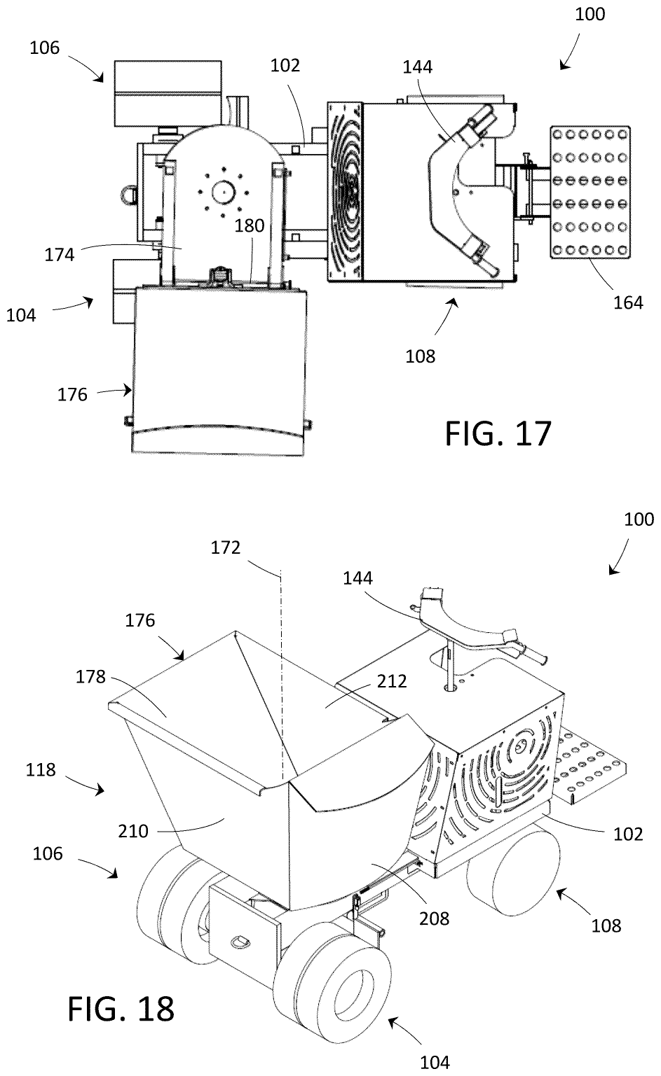

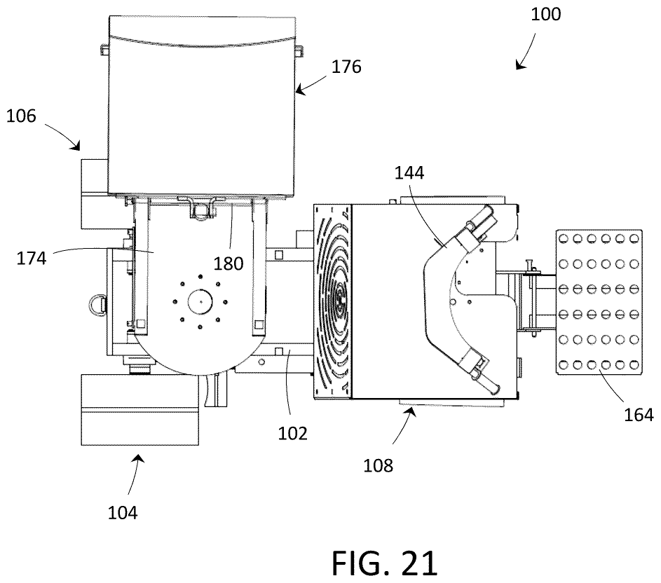

FIGS. 1-25 illustrate an example embodiment of a vehicle 100 including one or more aspects of the present disclosure. The vehicle 100 is configured (e.g., is constructed and operable, etc.) to haul material between locations (e.g., at construction sites, etc.) and to selectively dump the material, as desired. Uniquely herein, the example vehicle 100 is configured with power steering (or power assisted steering) and a pivoting steering/control wheel assembly to provide added control and/or stability to the vehicle 100 when used by an operator (e.g., to haul material, to dump material, etc.). That said, any suitable material may be hauled (and selectively dumped) by the vehicle 100 within the scope of the present disclosure including, for example, aggregate, concrete, dirt/soil, etc.

As shown in FIGS. 1-3, the vehicle 100 includes a frame 102 (or chassis) supporting the vehicle 100 (e.g., supporting the various parts and/or components of the vehicle 100, etc.), and two forward wheel assemblies 104, 106 and a rearward wheel assembly 108 (or steering/control wheel assembly) coupled thereto. The wheel assemblies 104-108 position the frame 102 generally above a ground surface and facilitate movement of the vehicle 100, as desired, across the ground surface (e.g., where the ground surface may include dirt, grass, rock, asphalt, concrete, flooring of a building, etc.). That said, the frame 102 may be constructed from suitable material capable of supporting the various parts and/or components of the vehicle 100, including, for example, one or more metals, alloys, etc.

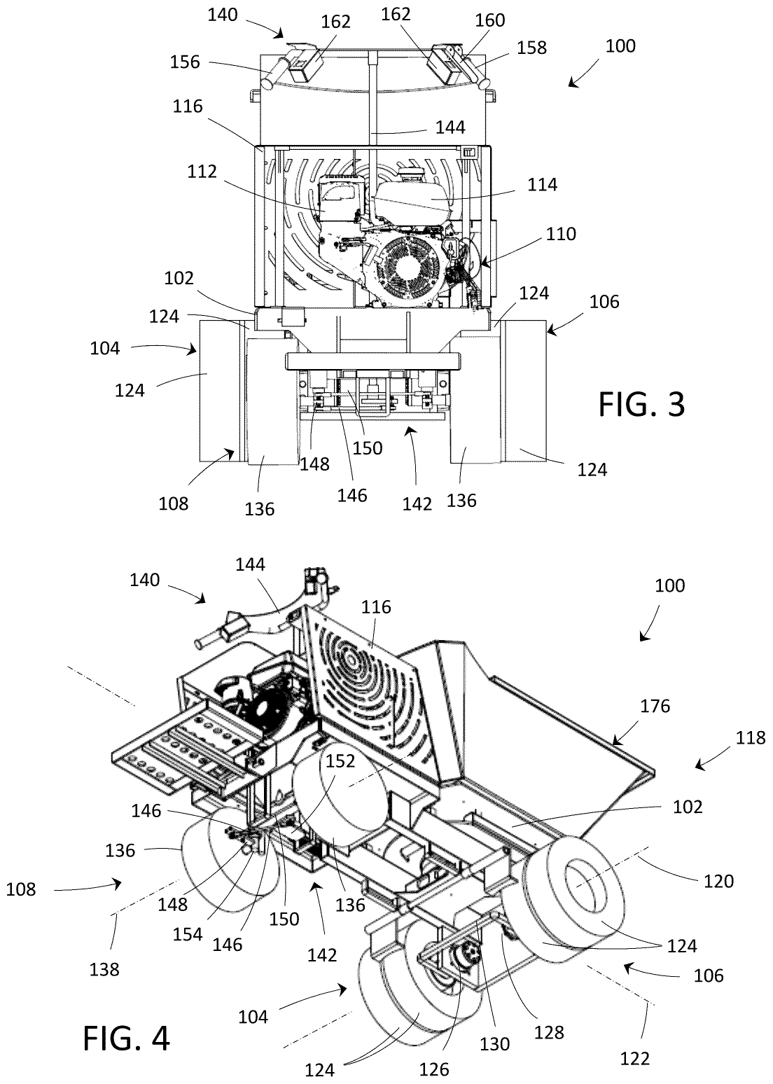

The vehicle 100 also includes an engine 110 mounted on the frame 102 generally between the forward wheel assemblies 104, 106 and the rearward wheel assembly 108, to provide power to the vehicle 100 to move the vehicle 100 and operate the various components and/or parts of the vehicle 100 (such that the vehicle 100 may be viewed as a motorized vehicle 100, etc.). An air filter 112 and fuel tank 114 (FIG. 3) are provided in communication with the engine 110. And, a cover 116 is provided over these components (e.g., the engine 110, the air filter 112, the fuel tank 114, etc.) to provide protection thereto (in the illustrated embodiment, a rear portion of the cover 116 is removed to allow for illustration of the engine 110). The engine 110 may include any suitable engine 110 within the scope of the present disclosure. For example, the engine 110 may include a four-stroke engine of about 10-15 horsepower. Or, the engine 110 may include a larger engine of about 20 horsepower or more. That said, it should be appreciated that, more generally, any suitable engine may be used with the vehicle 100.

With additional reference to FIG. 4, the forward wheel assemblies 104, 106 of the vehicle 100 are located toward a forward end of the frame 102, adjacent a bucket assembly 118 of the vehicle 100, and include a first wheel assembly 104 and a second wheel assembly 106. The first and second forward wheel assemblies 104, 106 are spaced apart from each other, and are generally aligned along a forward axis 120 of the vehicle 100, where the forward axis 120 is then oriented generally perpendicular to a longitudinal axis 122 of the frame 102. In connection therewith, the first forward wheel assembly 104 is located toward a left side (or first side) of the frame 102 (as viewed in FIG. 3). And, the second forward wheel assembly 106 is located toward a right side (or second side) of the frame 102 (as viewed in FIG. 3).

In addition, each of the first and second forward wheel assemblies 104, 106 includes two tires (each indicated by reference number 124) located generally outside of (e.g., lateral of, etc.) the frame 102. The two tires 124 of each of the forward wheel assemblies 104, 106 are then positioned adjacent each other, and slightly separated (e.g., by a spacer, etc.). The tires 124 of each of the first and second forward wheel assemblies 104, 106 are further interconnected by (e.g., held together by, supported by, etc.) a respective axle 126, 128 (or hub unit). In particular, the tires 124 of the first forward wheel assembly 104 are interconnected by a first axle 126 (or hub unit) and the tires 124 of the second forward wheel assembly 106 are interconnected by a second axle 128 (or hub unit). The first and second axles 126, 128, in turn, are coupled to the frame 102 at a wheel mount 130 extending generally away from the frame 102 (e.g., by suitable bearings, etc.). And, the first and second axles 126, 128 are generally oriented in alignment with the forward axis 120 of the vehicle 100. The tires 124 of the first and second forward wheel assemblies 104, 106 may be operated (e.g., rotated, etc.), as described more below, to cause movement of the vehicle 100. That said, the tires 124 of the first and second forward wheel assemblies 104, 106 may include any suitable tires (e.g., rubber wheeled tires, etc.) within the scope of the present disclosure.

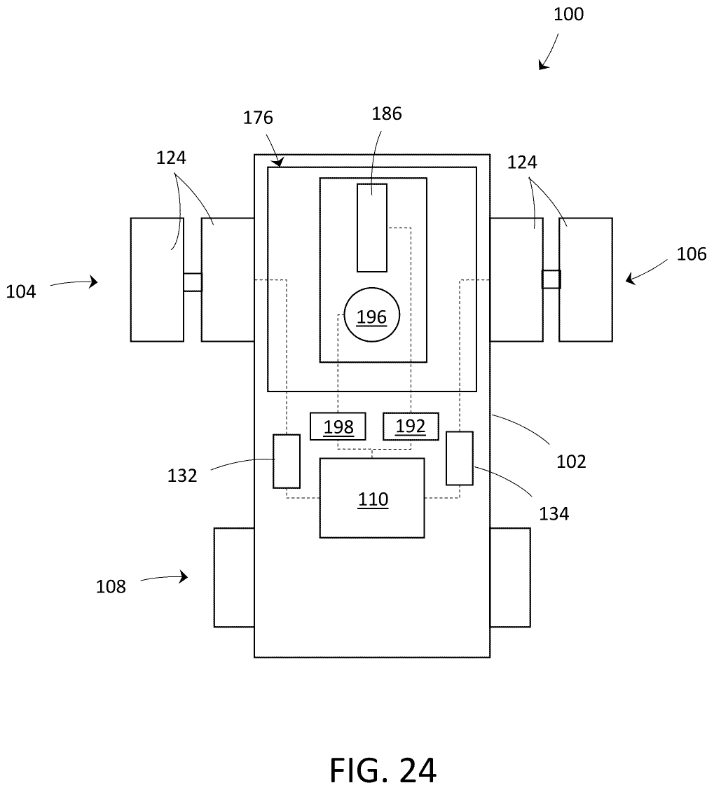

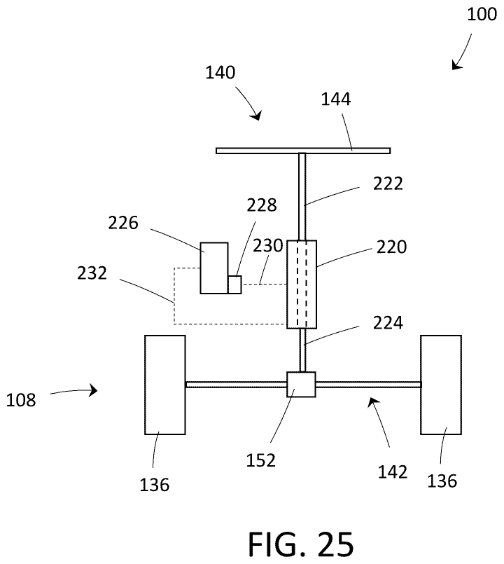

The first and second forward wheel assemblies 104, 106 also each include a wheel motor 132, 134 configured to selectively rotate the tires 124 of the given assembly (see, e.g., FIG. 24). In particular, a first wheel motor 132 (e.g., a hydraulic motor, etc.) is coupled to the first axle 126, to selectively rotate the tires 124 of the first forward wheel assembly 104. And, a second wheel motor 134 (e.g., a hydraulic motor, etc.) is coupled to the second axle 128 to selectively rotate the tires 124 of the second forward wheel assembly 106. In this manner, the tires 124 of the first forward wheel assembly 104 are independently operable/moveable relative to the tires 124 of the second forward wheel assembly 106, by way of the respective first and second wheel motors 132, 134, to thereby allow for added control of the vehicle 100 (whereby specific power and operation can be provided to each of the first and second forward wheel assemblies 104, 106, as desired, to help drive, move, direct the vehicle 100, etc.). In one example embodiment, the first and second wheel motors 132, 134 both include hydraulic motors coupled to a hydraulic reservoir (e.g., tank 226 which may be located in tank compartment 242, etc.) (for providing fluid to the motors 132, 134) (e.g., located behind the engine 110 in FIGS. 3 and 8, etc.) (see, e.g., also FIG. 25, etc.). In connection therewith, in this example, the hydraulic motors are coupled to the reservoir in a generally open loop configuration so that fluid is provided (e.g., via pump 228, etc.) to the motors in a manner that powers the forward wheel assemblies 104, 106 on an on-demand basis (e.g., power goes to whichever wheel assembly needs it the most at the time, etc.).

The location and spacing of the tires 124 of the first and second forward wheel assemblies 104, 106, as described above, may provide a generally wider and more stable stance for the vehicle 100 (at a front of the vehicle 100), as compared to vehicles having forward wheel assemblies with single tires and/or vehicles having single tracks, to resist (or inhibit) tipping when hauling and/or dumping material. The location and spacing of the two tires 124 of each of the first and second forward wheel assemblies 104, 106 may also increase an area of contact between the tires 124 and the ground surface to thereby spread a weight of the vehicle 100 (and material hauled thereby) over a larger surface area, again as compared to vehicles having forward wheel assemblies with single tires and/or vehicles having single tracks, to resist (or inhibit) sinking of the vehicle 100 into the ground surface (or otherwise damaging the ground surface (e.g., cracking it, rutting it, etc.), etc.). That said, in the illustrated embodiment, as an example, a width of the vehicle 100, as defined by a spacing of (or between) outer ones of the tires 124 of the first and second forward wheel assemblies 104, 106 (e.g., as measured generally along the forward axis 120 from an outer portion of the outer tire 124 of the first forward wheel assembly 104 to an outer portion of the outer tire 124 of the second forward wheel assembly 106, etc.), may be between about 35 inches and about 50 inches (e.g., about 45 inches, etc.).

Referring still to FIGS. 1-4, the rearward wheel assembly 108 (or steering/control wheel assembly) of the vehicle 100 is located toward a rearward end of the frame 102, adjacent the engine 110, and includes two spaced apart tires (each indicated by reference number 136). A first of the tires 136 is located toward the left side (or first side) of the frame 102 and a second of the tires 136 is located toward the right side (or second side) of the frame 102 (as viewed in FIG. 3). The first and second tires 136 are spaced apart from each other along a rearward axis 138, that is generally perpendicular to the longitudinal axis 122 of the frame 102 (and that is generally parallel to the forward axis 120 of the vehicle 100). In addition in the illustrated embodiment, the first one of the tires 136 (the left tire 136 as viewed in FIG. 3, etc.) is generally aligned with an inner tire 124 of the first forward wheel assembly 104 and the second one of the tires 136 (the right tire 136 as viewed in FIG. 3, etc.) is generally aligned with an inner tire 124 of the second forward wheel assembly 106. In connection therewith, the rearward axis 138 may be spaced apart from the forward axis 120 by a distance of between about 40 inches and about 60 inches. In one particular implementation, the rearward axis 138 may be spaced apart from the forward axis 120 by a distance of between about 45 inches and about 55 inches (e.g., about 50 inches, etc.).

As described for the forward wheel assemblies 104, 106, this positioning/spacing of the tires 136 of the rearward wheel assembly 108, along the rearward axis 138, may provide a generally wider and more stable stance for the vehicle 100, at the rearward end of the frame 102, to further resist (or inhibit) tipping of the vehicle 100 when hauling (e.g., moving, etc.) and/or dumping material (alone or in combination with the location and/or spacing of the tires 124 of the forward wheel assemblies 104, 106). That said, in the illustrated embodiment, a width of the vehicle 100, as defined by a spacing of the tires 136 of the rearward wheel assembly 108 (e.g., as measured generally along the rearward axis 138 from an outer portion of the first one of the tires 136 to an outer portion of the second one of the tires 136, etc.), may be between about 12 inches and about 40 inches. And, in one particular implementation, the width of the vehicle 100, as defined by the first and second tires 136 of the rearward wheel assembly 108, is between about 25 inches and about 36 inches (e.g., about 33 inches, etc.).

The first and second tires 136 of the rearward wheel assembly 108 are controllable by a steering assembly 140 to thereby allow for directing (or steering) a movement of the vehicle 100 (broadly, for controlling directional movement of the vehicle 100). In connection therewith, the tires 136 are connected by a steering linkage 142 (FIG. 4) of the steering assembly 140. And, a handle 144 of the steering assembly 140 is coupled to the steering linkage 142, by way of a power steering unit 220. Together, then, the handle 144, the power steering unit 220, and the steering linkage 142 are configured to control movement (e.g., turning, rotating, etc.) of the tires 136 of the rearward wheel assembly 108. In particular, an operator can manipulate (e.g., turn, etc.) the handle 144 of the steering assembly 140 to actuate, via the power steering unit 220, an arm 146 of the steering linkage 142 (coupled to the handle 144) and thereby move the two tires 136 of the rearward wheel assembly 108 (via a mount 148 coupled to a center link 150 interconnecting the tires 136) to allow for steering the vehicle 100 as the vehicle 100 moves. Such steering of the vehicle 100 may be done alone by the rearward wheel assembly 108 (by way of the steering assembly 140), or it may be in combination with selective operation of the wheel motors 132, 134 of the forward wheel assemblies 104, 106. That said, the tires 136 of the rearward wheel assembly 108 may include any suitable tires (e.g., rubber wheeled tires, etc.) within the scope of the present disclosure.

In the illustrated embodiment, the handle 144 generally includes a T-shaped handle (e.g., the handle 144 does not include a circular wheel, etc.). In connection therewith, in the illustrated embodiment, the handle 144 is configured with limited rotation (or limited travel) for controlling movement (e.g., turning, rotating, steering, etc.) of the tires 136 of the rearward wheel assembly 108. For instance, the handle 144 may be configured to rotate only about 270 degrees or less (e.g., about 135 degrees to the left of center (e.g., to the left of the axis 122, etc.) and about 135 degrees to the right of center (e.g., to the right of the axis 122, etc.), etc.) (e.g., less than a full rotation/revolution of the handle 144, less than 360 degrees, etc.) for controlling the tires 136 and steering the vehicle 100.

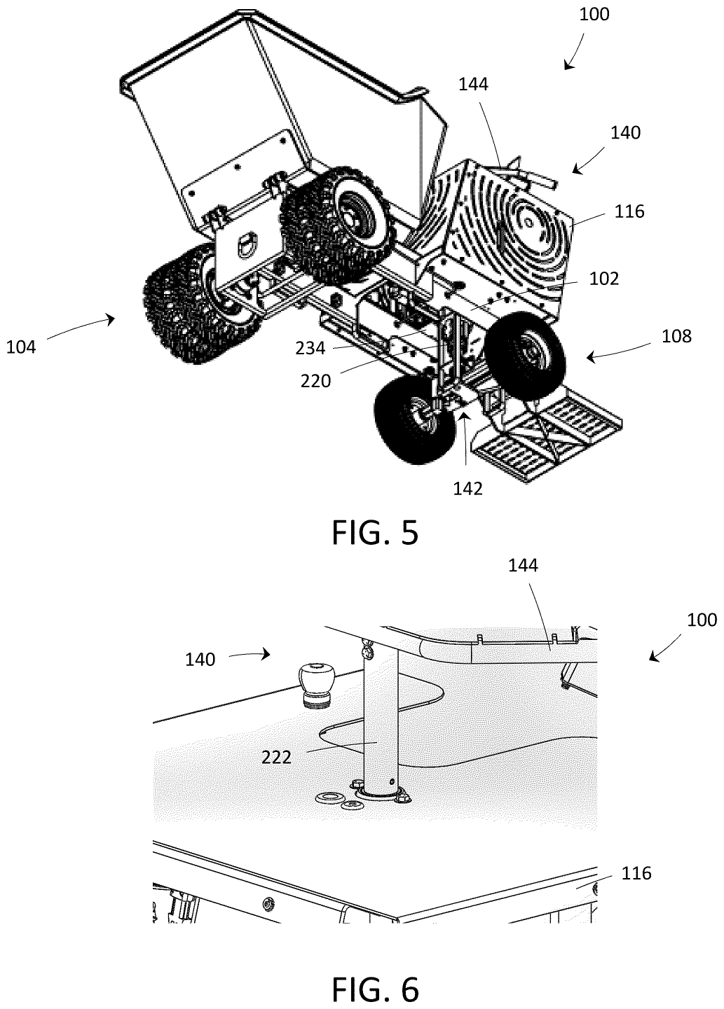

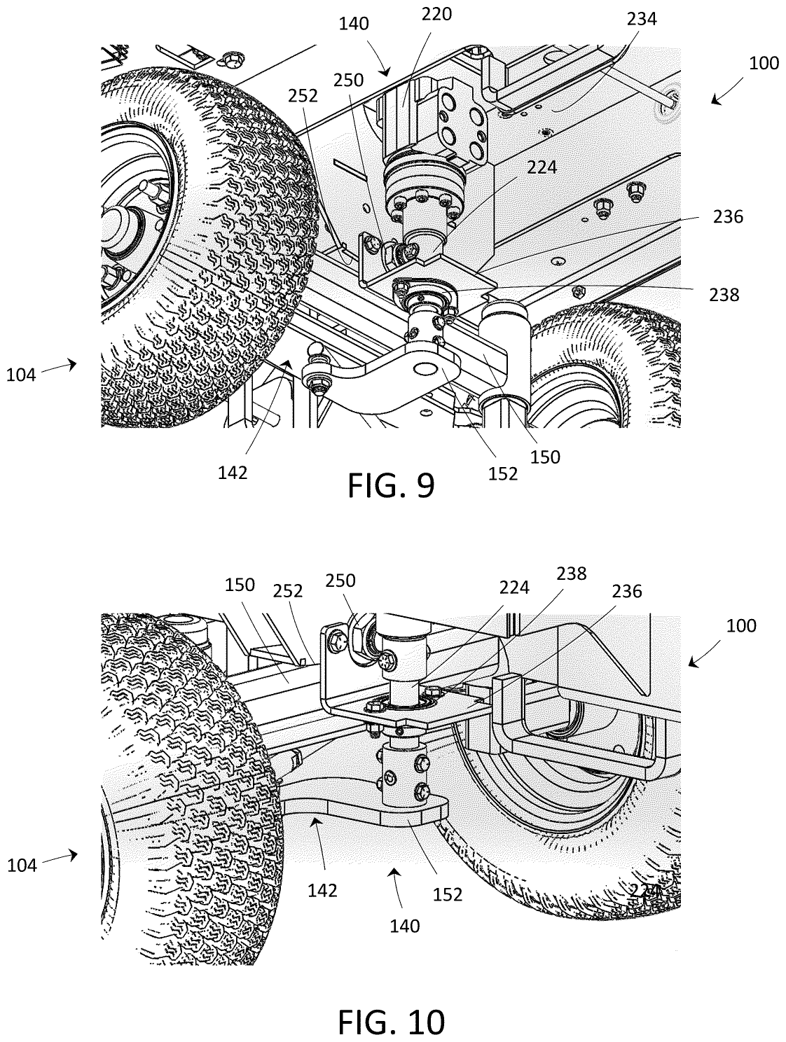

With additional reference to FIGS. 5-10, the power steering unit 220 of the steering assembly 140 is located generally below (or within) the frame 102 of the vehicle 100 (e.g., generally below the engine 110, generally below a floor support 234 of the vehicle 100, generally coupled to an underside of the floor support 234 of the vehicle 100 via fasteners 244 (FIGS. 8 and 9), etc.). In this position, the power steering unit 220 is coupled/located/spliced between the handle 144 and the steering linkage 142. In particular, an input shaft 222 (e.g., a steering shaft, etc.) extends from the handle 144 downward through the cover 116 (via a locking collar 240 (and associated bearing) coupled to the cover 116) (adjacent the engine 110), through the frame 102 (and through the floor support 234 of the frame 102), and into the power steering unit 220, thereby coupling the handle 144 (and the input shaft 222 thereof) to the power steering unit 220. And, an output shaft 224 then extends from the power steering unit 220 to the steering linkage 142 (through support 236 and steering bearing 238 coupled to the frame 102), thereby coupling the steering linkage 142 and the rearward wheel assembly 108 to the power steering unit 220.

In the illustrated embodiment, the steering linkage 142 connecting the first and second tires 136 of the rearward wheel assembly 108 includes the center link 150 interconnecting the first and second tires 136, the mount 148 coupled to the center link 150, and the arm 146 coupled between the mount 148 and the output shaft 224 (via a base member 152). In addition in the illustrated embodiment, the handle 144 is located or positioned generally above (e.g., in generally vertical alignment with, etc.) the rearward wheel assembly 108 (e.g., the tires 136 of the rearward wheel assembly 108, the center link 150 of the rearward wheel assembly 108, etc.). This generally “stacked” arrangement of the steering assembly 140 and the rearward wheel assembly 108 in the illustrated vehicle 100 accommodates control of the vehicle by an operator standing on operator stand 164.

In connection therewith, as the handle 144 rotates for steering (e.g., an amount less than about 270 degrees, etc.), it correspondingly rotates the input shaft 222 at the power steering unit 220. The power steering unit 220 recognizes the movement of the input shaft 222 (e.g., via a sensor, via movement of a through shaft of the power steering unit 220, etc.) and provides assisted force to rotate the output shaft 224 in a corresponding manner to the rotation of the input shaft 222 (and handle 144). The output shaft 224 (as rotated with assistance from the power steering unit 220) then pushes or pulls on the arm 146 of the steering linkage 142 (via the base member 152). In turn, the arm 146 pushes or pulls on the mount 148, which causes movement of the center link 150. And, the center link 150 then causes the first and second tires 136 of the rearward wheel assembly 108 to rotate via pivots 154. In this arrangement, the handle 144 is not rigidly/directly coupled to the first and second tires 136, whereby less stress is imposed on the handle 144 during operation of the vehicle 100. Similarly, in response to unexpected rotating movement of the first and second tires 136, for example, when moving the vehicle 100 across rough or uneven terrain, the power steering unit 220 may absorb at least some of the rotating/pivoting/turning movement of the output shaft 224 (caused by turning movement of the first and second tires 136) so that the handle 144 (via corresponding rotation of the input shaft 222) does not abruptly turn and strike the operator, etc. (e.g., provides bump control for the vehicle 100, inhibits or minimizes impact of the driving surface on the first and second tires 136 from transferring back up to the handle 144 (and operator) and potentially causing injuries, etc.). It should be appreciated that a different steering linkage 142 and/or steering assembly 140 in general may be used in other embodiments to allow for moving the tires 136 of the rearward wheel assembly 108, for steering the vehicle 100, including, for example, a rack and pinion steering mechanism, etc.

The power steering unit 222 may include a suitable power steering unit within the scope of the present disclosure. For instance, in one example, the power steering unit 222 includes a hydraulic power steering system, in which an actuator (e.g., a hydraulic cylinder of a servo system, etc.) directly interacts with the input shaft 220 and the output shaft 222 to provide steering ability to the rearward wheel assembly 108. In one particular example, the power steering unit 222 may include a torque generator or an orbital valve. In another example, the power steering unit 222 includes an electric power steering system, in which an electric motor interacts with the input shaft 220 and the output shaft 222 to provide steering ability to the rearward wheel assembly 108.

The illustrated vehicle 100 also includes a pivot 250 associated with the rearward wheel assembly 108. In particular, as best shown in FIGS. 9 and 10, the pivot 250 couples the center link 150 of the steering linkage 142 to the frame 102 of the vehicle 100. The pivot 250, then, includes a bushing that allows for rotation of the center link 150 (and thus, the first and second tires 136 of the rearward wheel assembly 108) relative to the frame 102 (e.g., pivoting movement in a generally vertical direction of the frame 102 (e.g., rotationally about the axis 122, etc.), etc.). In connection therewith, the frame 102 includes angled stops 252 to limit the pivoting movement of the center link 150 (via engagement of the center link 150 with the stops 252, etc.). In this way, additional ride control is provided to the vehicle 100, for example, allowing the first and second tires 136 to move/accommodate uneven portions of a ground surface to help maintain contact of the tires 136 with the ground surface, etc. (e.g., the first and second tires 136 are not rigidly connected to the frame 102 of the vehicle 100, etc.).

In addition in the illustrated embodiment, the handle 144 of the steering assembly 140 includes left and right grips 156, 158 (as viewed in FIG. 3) (e.g., on left and right end portions of the T-shape of the handle 144, etc.). Various operations of the vehicle 100 may be controlled at or near the grips 156, 158, such that an operator may control (and operate) the vehicle 100 while holding (and/or while near) the handle 144. For instance, a speed of the vehicle 100 and braking of the vehicle 100 may be controlled by manipulating the right grip 158 (e.g., rotating the grip 158, etc.) and/or an actuator 160 associated with the right grip 158. And, dumping operation of the vehicle 100 may be controlled by manipulating one or more of the actuators (each indicated by reference number 162) mounted on the handle 144 adjacent the right and left grips 156, 158. That said, it should be appreciated that the steering assembly 140 may include handles and/or grips having other configurations and/or arrangements, and/or having other configurations and/or arrangements of controls, actuators, etc. in other embodiments.

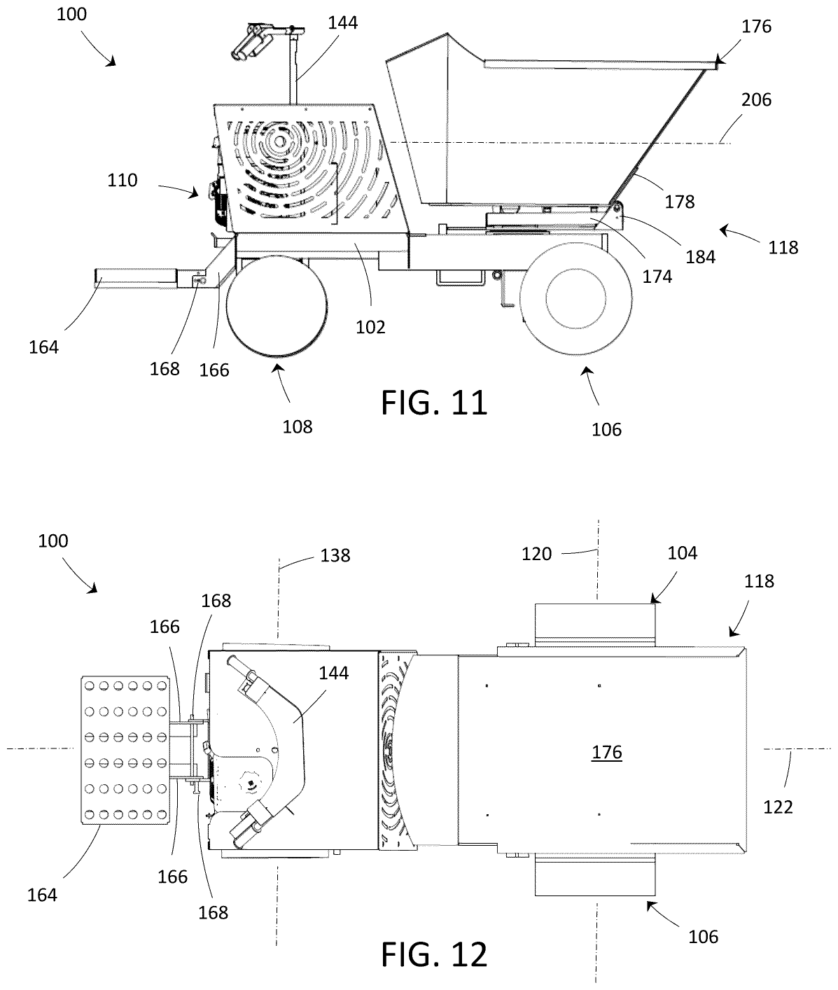

With reference to FIGS. 11-12, the vehicle 100 also includes the operator stand 164 (or platform) located toward the rearward end of the frame 102. The stand 164 is configured to permit an operator to step (and stand) on the stand 164 and ride on the vehicle 100, for example, while operating the vehicle 100 (e.g., while holding the handle 144, etc.). In the illustrated embodiment, the stand 164 is configured to move between an operating position (FIGS. 11 and 12) for supporting the operator, and a stored position in which the stand 164 is folded generally upwardly and inwardly toward the handle 144 (e.g., for transporting the vehicle 100, for allowing the operator to walk behind the vehicle 100, etc.). In connection therewith, the stand 164 is pivotally mounted to the frame 102 via support arms (each indicated by reference number 166) extending from the frame 102, to allow for the movement of the stand 164 between the operating position and the stored position. Locking pins (each indicated by reference number 168), then, are provided to secure the stand 164 in either the operating position or the stored position (e.g., via alignment of openings in the support arms and/or stand with the locking pins 168, etc.).

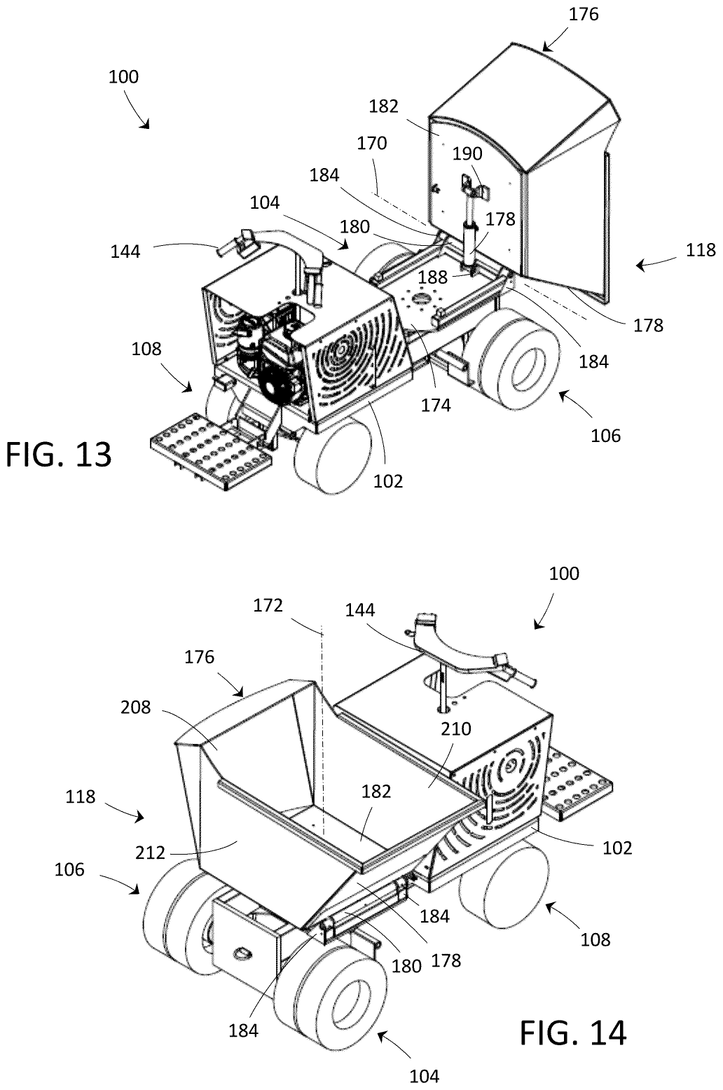

Referring now to FIGS. 13-21, the vehicle 100 includes the bucket assembly 118, which is supported by the frame 102 toward the forward end of the frame 102. The bucket assembly 118 is disposed adjacent the forward wheel assemblies 104, 106. In general, the bucket assembly 118 is configured to pivot about a first axis 170 (FIG. 13) of the bucket assembly 118 (e.g., a horizontal axis, etc.) to dump material from the vehicle 100. In addition, the bucket assembly 118 is also configured to rotate about a second axis 172 (FIG. 14) of the bucket assembly 118 (e.g., a vertical axis of the bucket assembly 118 or of the frame 102, etc.) to move the bucket assembly 118 in generally a radial direction about the frame 102 (and relative to the frame 102) to a desired angle. This will be described in more detail next.

The bucket assembly 118 includes a platform 174 mounted on the frame 102, and a bucket 176 coupled to the platform 174. The bucket 176 is coupled to the platform 174 adjacent a forward wall 178 of the bucket 176 (FIGS. 13 and 14). The bucket 176 includes a pivot 180 (broadly, a mount) (e.g., a bar, a tube, etc.) coupled to the forward wall 178 (generally where the forward wall 178 intersects with a bottom wall 182 of the bucket 176 (e.g., along the horizontal axis 170 of the bucket assembly 118, etc.) and configured to fit within corresponding mounts 184 (e.g., openings, rings, etc.) of the platform 174. And, a hydraulic cylinder 186 or piston (broadly, an actuator) (FIG. 13) is positioned generally between the bucket 176 and the platform 174, with a cylinder portion of the cylinder 186 coupled to a mount 188 of the platform 174 and a rod portion of the cylinder 186 coupled to a bracket 190 of bucket 176. The cylinder 186 is then configured to actuate the bucket 176, by way of a hydraulic pump 192 (e.g., a hydrostatic pump, etc.) (see, FIG. 24), as powered by the engine 110 of the vehicle 100, to cause the bucket 176 to pivot relative to the platform 174 via the pivot 180 (e.g., to rotate, tilt, etc.) and selectively dump material from the bucket 176, etc. In the illustrated embodiment, the bucket 176 is configured to pivot about 90 degrees relative to the platform 174, but may pivot more or less in some implementations (e.g., about 45 degrees, about 100 degrees, etc.).

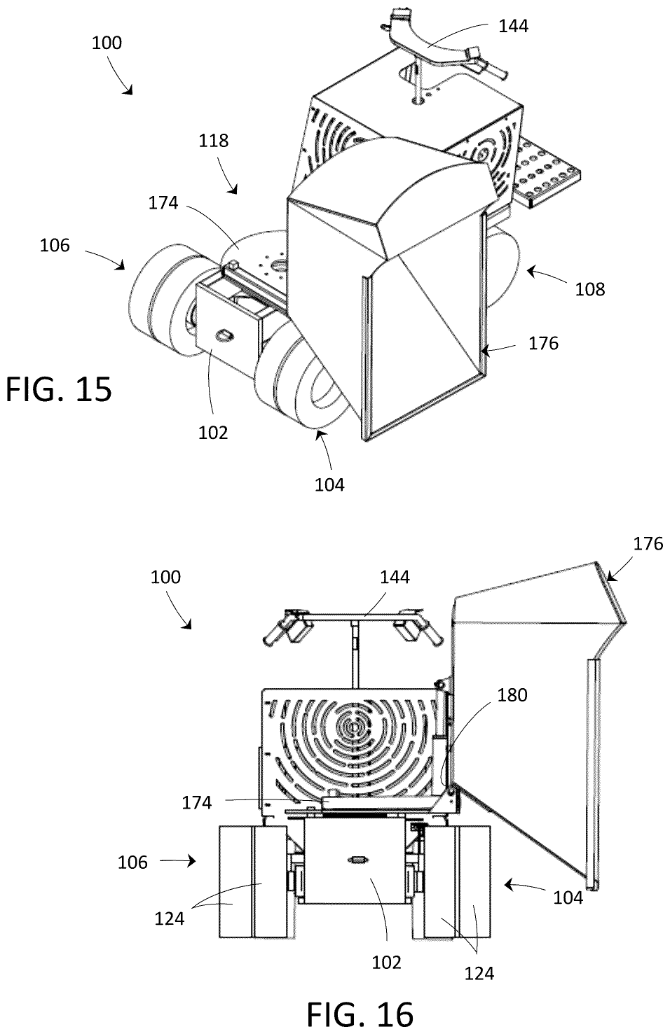

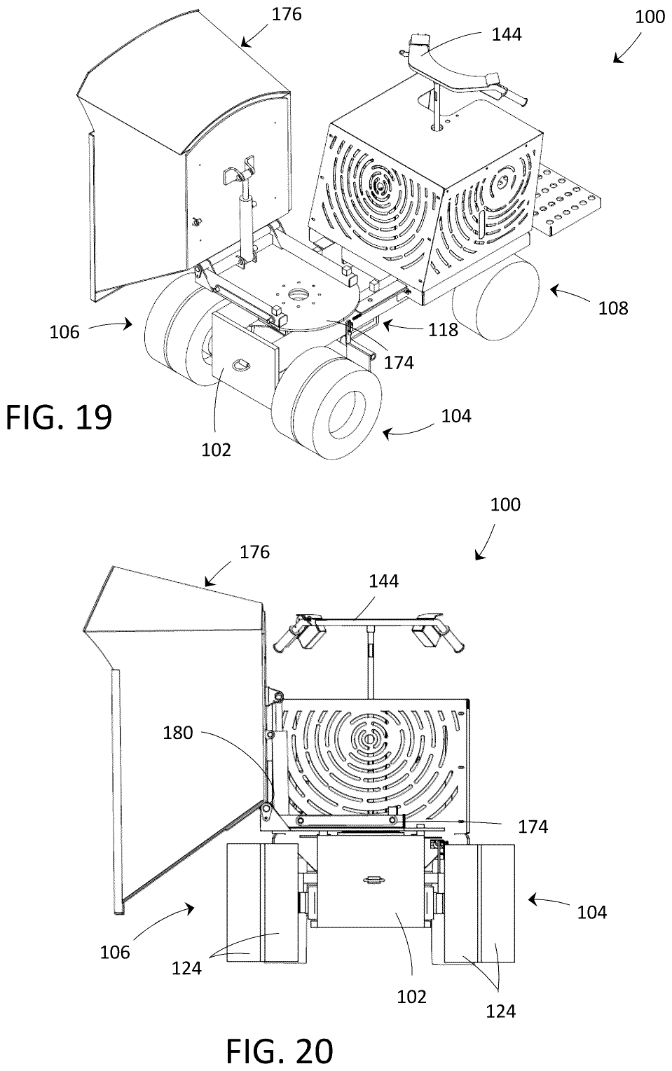

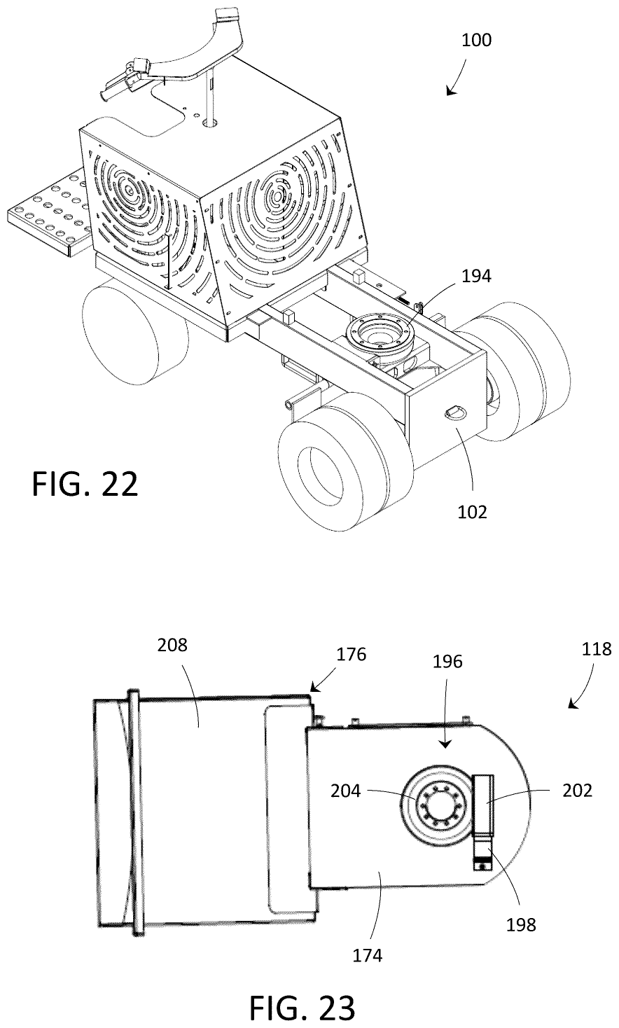

With additional reference to FIGS. 22 and 23, the platform 174 of the bucket assembly 118 is mounted on the frame 102 of the vehicle 100 at a bucket mount 194. A drive device 196 (broadly, an actuator) of the platform 174 is positioned at the bucket mount 194 and is configured to rotate the platform 174 (and bucket 176 coupled thereto) relative to the frame 102 (by way of a platform motor 198, as powered by the engine 110) (e.g., between the positions illustrated in FIGS. 2, 14, and 18; etc.). As such, the bucket 176 of the present disclosure is configured to rotate about the vertical axis 172 of the bucket assembly 118 between a plurality of different radial positions (relative to the frame 102 of the vehicle 100). Such rotation may be done while the bucket 176 is in a hauling position (e.g., FIGS. 14 and 18, etc.) or while the bucket 176 is in a dumping position (e.g., FIGS. 15 and 19, etc.). In this way, the vehicle 100 is able to dump material from the bucket 176 generally straight forward of the vehicle 100 (in a forward dumping position) (FIG. 13), or to a left side of the vehicle 100 (in a left-side dumping position) (e.g., FIGS. 14-17, etc.), or to a right side of the vehicle 100 (in a right-side dumping position) (e.g., FIGS. 18-21, etc.). That said, in the illustrated embodiment the drive device 196 includes a slew ring drive coupled between the bucket mount 194 of the frame 102 and the platform 174 and configured to cause rotation of the platform 174 and bucket 176. In connection therewith, the platform motor 198 is configured to turn a worm shaft 202, which is coupled to a wheel 204 disposed on the platform 174 (and which is configured to fit within the bucket mount 194). As the worm shaft 202 turns, then, it actuates the wheel 204, which correspondingly rotates the platform 174 (and bucket 176). However, in other embodiments, the drive device 196 (or actuator) may include another drive mechanism, for example, a rack and pinion drive, a cylinder (or multi-cylinder) drive, etc. configured to similarly rotate the platform 174 (and bucket 176) relative to the frame 102.

In the illustrated embodiment, the bucket 176 may be configured to rotate, for example, from a hauling position (e.g., a first radial position, etc.), in which a longitudinal axis 206 (FIG. 11) of the bucket 176 is generally parallel with the longitudinal axis 122 of the frame 102 of vehicle 100, to a left-side position (e.g., a second radial position, etc.) in which the longitudinal axis 206 of the bucket 176 is generally perpendicular to the longitudinal axis 122 of the frame 102 (e.g., about 90 degrees to the left side of the vehicle 100, etc.) (FIG. 14). Similarly, the bucket 176 may be configured to rotate from the hauling position (e.g., the first radial position, etc.), in which the longitudinal axis 206 of the bucket 176 is generally parallel with the longitudinal axis 122 of the frame 102 of vehicle 100, to a right-side position (e.g., a third radial position, etc.) in which the longitudinal axis 206 of the bucket 176 is generally perpendicular to the longitudinal axis 122 of the frame 102 (e.g., about 90 degrees to the right side of the vehicle 100, etc.) (FIG. 18). In both of the above examples, when the bucket 176 is in the left-side position or the right-side position, at least part of the pivot 180 is positioned over at least one of the tires 124 of the first forward wheel assembly 104 or over at least one of the tires 124 of the second forward wheel assembly 106 (FIGS. 16 and 20). That said, it should be appreciated that the bucket 176 may also be configured to rotate to multiple other different radial positions (e.g., about 110 degrees to the lift side of the frame 102, about 45 degrees to the left side of the frame 102, about 45 degrees to the right side of the frame 102, about 110 degrees to the right side of the frame 102, etc.) in other examples. In addition, in some embodiments, the bucket 176 (and/or platform 174) may be moveable in a generally vertical direction relative to the vehicle 100 (e.g., in a direction generally parallel to the vertical axis 172 of the bucket 176, etc.).

The bucket 176 of the bucket assembly 118 is configured to hold material being hauled by the vehicle 100, and to subsequently dump the material as desired (e.g., straight forward of the vehicle 100, to a side of the vehicle 100, etc.). In addition, the bucket 176 may be constructed from suitable material (e.g., plastics, metals, combinations thereof, etc.) and may have any suitable and/or desired capacity. For instance, in some embodiments, the bucket 176 may be constructed from a plastic material and may have a capacity of at least about 10 cubic feet (e.g., about 10 cubic feet, about 15 cubic feet, about 16 cubic feet, about 21 cubic feet, etc.), and a payload of at least about 1000 pounds (e.g., about 1000 pounds, about 1500 pounds, about 2000 pounds, about 2500 pounds, about 3000 pounds, etc.). Further in the illustrated embodiment, the bucket 176 defines a generally rectangular shape. In connection therewith, the bucket 176 includes the bottom wall 182 (or floor), the forward wall 178 (coupled to the bottom wall), a rearward wall 208 adjacent the engine 110 (and coupled to the bottom wall 182), and opposing side walls 210, 212 (each coupled to the bottom wall) (FIG. 14). The forward wall 178 is generally lower than the rearward wall 208 and is angled (or sloped) relative to the bottom wall 182 to facilitate dumping material from the bucket 176. The side walls 210, 212 are generally vertical and have a similar height to the forward wall 178. And, the rearward wall 208 is sloped and is relatively higher than the forward wall 178 so as to increase carrying capacity of the bucket. It should be appreciated that the walls 178, 182, 208, 210, 212 of the bucket 176, and more generally the bucket 176 itself, may have different configurations in other embodiments.

FIG. 24 schematically illustrates the vehicle 100, and a configuration of the engine 110 of the vehicle 100 as mounted on the frame 102. As shown, and as described above, the engine 110 is generally located between the forward wheel assemblies 104, 106 and the rearward wheel assembly 108 (and generally closer to the rearward wheel assembly 108). And, the engine 110 is configured to provide power to the different parts and/or components of the vehicle 100 to move the vehicle 100 and operate the bucket assembly 118.

For instance, the engine 110 is coupled (as indicated by the dashed lines in FIG. 24) to the first and second wheel motors 132, 134, to thereby selectively power the wheel motors 132, 134 (via the grip(s) 156, 158 of the handle 144 of the steering assembly 140 (FIG. 3)) to rotate the tires 124 of the first and second forward wheel assemblies 104, 106 to move the vehicle 100 forward or backward. In addition, the tires 124 of the first and second forward wheel assemblies 104, 106 are independently operable/moveable, by way of the respective first and second wheel motors 132, 134, to thereby allow for added control of the vehicle 100 (whereby specific power and operation can be provided to each of the first and second wheel assemblies 104, 106, as desired, to help direct the vehicle 100, etc.).

In addition, the engine 110 is coupled (as also indicated by the dashed lines in FIG. 24) to the platform motor 198 of the bucket assembly 118 to thereby power the motor 198 to selectively operate the drive device 196 to rotate the platform 174 (and bucket 176 coupled thereto), relative to the frame 102. In connection therewith, the vehicle 100 is able to dump material from the bucket 176 generally straight forward (or straight ahead) of the vehicle 100, or to a left side of the vehicle 100 or a right side of the vehicle 100. Further, the engine 110 is also coupled (as indicated by the dashed lines in FIG. 24) to the hydraulic pump 192 associated with the cylinder 186 of the bucket assembly 118 to thereby cause the bucket 176 to pivot relative to the platform 174 to dump material from the bucket 176. This may be done while the bucket 176 is in a hauling position (FIGS. 2, 14, and 18) or in a dumping position (FIGS. 13, 15, and 19).

FIG. 25 schematically illustrates the vehicle 100, and an example configuration of the steering assembly 140 as included in the vehicle 100 (e.g., as mounted on the frame 102 of the vehicle 100 via the support 236, etc.). As shown, and as described above, the steering assembly 140 is associated with the rearward wheel assembly 108 of the vehicle 100 and is generally located adjacent the engine 110 (see, FIGS. 2 and 3) (e.g., generally aligned/stacked over the rearward wheel assembly 108 (e.g., generally over the center link 150, etc.), etc.).

The input shaft 222 (or steering shaft) extends from the handle 144 to the power steering unit 220. And, the output shaft 224 then extends from the power steering unit 220 to the base member 152 of the steering linkage 142. In this example, the power steering unit 220 includes a torque generator having a through-shaft therein (to which the input shaft 222 and the output shaft 224 connect). As such, in this example, the power steering unit 220 is fluidly coupled to tank 226 (e.g., located adjacent the engine 110 in tank compartment 242 (FIG. 8), etc.) configured to hold hydraulic fluid for use in the power steering unit 220, and to pump 228 configured to circulate the hydraulic fluid between the tank 226 and the power steering unit 220 (via supply and return lines 230, 232) (e.g., providing a pressure of hydraulic fluid at the power steering unit 220 of about 300 psi or more or less, etc.). In connection therewith, as the handle 144 rotates for steering, it correspondingly rotates the input shaft 222 at the power steering unit 220. The power steering unit 220 recognizes the movement of the input shaft 222 (e.g., via the through-shaft thereof, etc.) and provides assisted force (via the through-shaft) to rotate the output shaft 224 in a corresponding manner, for example, via operation of the hydraulic fluid, an actuator, etc. on the through-shaft. The output shaft 224 (as rotated with assistance from the power steering unit, for example) then pushes or pulls on the steering linkage 142 (via the base member 152). In turn, the steering linkage 142 causes the first and second tires 136 of the rearward wheel assembly 108 to rotate/turn as desired.

In this example, the tank 226 and pump 228 are configured to provide hydraulic fluid to all parts of the vehicle, including the power steering unit 220, the wheel motors 132, 134 of the first and second forward wheel assemblies 104, 106, and the bucket assembly 118. However, this is not required in all embodiments (whereby separate tanks and/or pumps may be provided/used for different components of the vehicle 100).

In various embodiments, the power steering unit 220 may provide at least about 20% fluid assistance to the steering assembly 140 of the vehicle 100. In addition, in various embodiments, operation of the steering assembly 140 is maintained even if operation of the power steering unit 220 fails (e.g., via the linkage of the input shaft 222 and the output shaft 224 to the through-shaft of the power steering unit 220, etc.). In other words, the vehicle 100 may still be operated/controlled by the handle 144 of the steering assembly 140 even if operation of the power steering unit 220 fails or faulters.

In various embodiments, the power steering unit 220 described herein may be installed (e.g., as a retrofit, etc.) to a steering shaft of a motorized vehicle, such as a power buggy. In doing so, the steering shaft may be cut at a location generally below a frame (and/or floor support 234) thereof, and the power steering unit 220 then installed between the cut portions of the steering shaft.

The foregoing description of the embodiments has been provided for purposes of illustration and description. It is not intended to be exhaustive or to limit the present disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the present disclosure, and all such modifications are intended to be included within the scope of the present disclosure.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific material(s), and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A motorized vehicle for transporting material, the motorized vehicle comprising:
a frame having a longitudinal axis;
first and second forward wheel assemblies, the first forward wheel assembly including at least one tire disposed toward a first side of the frame and the second forward wheel assembly including at least one tire disposed toward a second side of the frame, the at least one tire of the first forward wheel assembly spaced apart from the at least one tire of the second forward wheel assembly along a forward axis, the forward axis disposed generally perpendicular to the longitudinal axis of the frame;
a rearward wheel assembly including a first tire disposed toward the first side portion of the frame and a second tire disposed toward the second side portion of the frame, the first tire of the rearward wheel assembly spaced apart from the second tire of the rearward wheel assembly along a rearward axis, the rearward axis disposed generally perpendicular to the longitudinal axis of the frame;
an engine supported by the frame and configured to rotate the at least one tire of the first forward wheel assembly and the at least one tire of the second forward wheel assembly to thereby move the motorized vehicle;
a steering assembly comprising a power steering unit, the steering assembly configured to move the first and second tires of the rearward wheel assembly, via the power steering unit, for steering the motorized vehicle; and
a bucket assembly supported by the frame and configured to hold material on the motorized vehicle and selectively dump the material from the motorized vehicle, the bucket assembly disposed adjacent the first and second forward wheel assemblies.

2. The motorized vehicle of claim 1, wherein the steering assembly includes:
a handle;
an input shaft coupled between the handle and the power steering unit;
a steering linkage coupled to the first and second tires of the rearward wheel assembly; and
an output shaft coupled between the power steering unit and the steering linkage.

3. The motorized vehicle of claim 1, wherein the power steering unit is disposed below the frame.

4. The motorized vehicle of claim 1, wherein the power steering unit further includes a tank configured to hold fluid for use in the power steering unit, and a pump configured to circulate the fluid between the tank and the power steering unit.

5. The motorized vehicle of claim 1, wherein the first forward wheel assembly includes two tires, and wherein the second forward wheel assembly includes two tires.

6. The motorized vehicle of claim 5, wherein the two tires of the first forward wheel assembly are mounted on a first axle, and wherein the two tires of the second forward wheel assembly are mounted on a second axle separate from the first axle.

7. The motorized vehicle of claim 1, wherein the bucket assembly further includes:
a first actuator configured to pivot the bucket about the horizontal axis of the bucket assembly; and
a second actuator configured to rotate the platform about the vertical axis of the bucket assembly and move the bucket relative to the frame.

8. The motorized vehicle of claim 1, wherein the bucket assembly includes a mount configured to pivotally couple the bucket to the platform, the mount extending along the horizontal axis of the bucket assembly; and
wherein the bucket includes a bottom wall and a forward wall arranged at an angle relative to the bottom wall, the mount disposed adjacent an intersection of the bottom wall and the forward wall of the bucket.

9. The motorized vehicle of claim 1, further comprising a pivot coupling the rearward wheel assembly to the frame, so that the rearward wheel assembly is configured to pivot relative to the frame via the pivot.

10. A motorized vehicle for transporting material, the motorized vehicle comprising:
a frame having a longitudinal axis;
first and second forward wheel assemblies coupled to the frame, the first forward wheel assembly disposed toward a first side of the frame and the second forward wheel assembly disposed toward a second side of the frame;
a rearward wheel assembly coupled to the frame;
an engine supported by the frame and configured to rotate the first and second forward wheel assemblies to thereby move the motorized vehicle;
a steering assembly comprising a power steering unit, the steering assembly configured to move the rearward wheel assembly, via the power steering unit, to steer the motorized vehicle; and
a bucket supported by the frame adjacent the first and second forward wheel assemblies, the bucket configured to hold material on the motorized vehicle and selectively dump the material from the motorized vehicle.

11. The motorized vehicle of claim 10, wherein the steering assembly includes:
a handle;
an input shaft coupled between the handle and the power steering unit;
a steering linkage coupled to the first and second tires of the rearward wheel assembly; and
an output shaft coupled between the power steering unit and the steering linkage.

12. The motorized vehicle of claim 11, wherein the power steering unit is disposed below the frame.

13. The motorized vehicle of claim 12, wherein the power steering unit further includes a tank configured to hold fluid for use in the power steering unit, and a pump configured to circulate the fluid between the tank and the power steering unit.

14. The motorized vehicle of claim 13, further comprising a platform coupled to the frame and configured to rotate about a vertical axis to rotate the bucket at least between the first radial position and the second radial position.

15. The motorized vehicle of claim 14, wherein the bucket is configured to rotate about a vertical axis at least between a first radial position in which a longitudinal axis of the bucket is generally parallel with the longitudinal axis of the frame and a second radial position in which the longitude axis of the bucket is oriented generally perpendicular to the longitudinal axis of the frame.

16. The motorized vehicle of claim 13, wherein the first forward wheel assembly includes at least one tire, and wherein the second forward wheel assembly includes at least one tire; and
wherein the rearward wheel assembly includes a first tire and a second tire, the first tire of the rearward wheel assembly generally aligned with the at least one tire of the first forward wheel assembly and the second tire of the rearward wheel assembly generally aligned with the at least one tire of the second forward wheel assembly.

17. The motorized vehicle of claim 10, further comprising a pivot coupling the rearward wheel assembly to the frame, so that the rearward wheel assembly is configured to pivot relative to the frame via the pivot.
